(19) United States
(12) Patent Application Publication
(10) Pub. No.: US 2026/0343162 A1
(43) Pub. Date: Oct. 29, 2026

(54) RECONFIGURABLE AUDIO SYSTEM

(71) Applicant: Cirrus Logic International Semiconductor Ltd., Edinburgh (GB)

(72) Inventors: Zhengyi XU, Fleet (GB); Chris RATTRAY, Newbury (GB); Edward CRANEY, Newbury (GB); Brent KARLEY, Austin, TX (US)

(73) Assignee: Cirrus Logic International Semiconductor Ltd., Edinburgh (GB)

(21) Appl. No.: 19/186,719

(22) Filed: Apr. 23, 2025

(51) Int. Cl. H04S 7/00

(52) U.S. Cl. CPC H04S 7/30

(57) ABSTRACT

A reconfigurable audio system operable in a first mode of operation and a second mode of operation, the reconfigurable audio system comprising: a first processing path for processing a first signal to generate a first processed output signal, wherein the first processing path comprises a first set of processing blocks; and a second processing path for processing a second signal to generate a second processed output signal, wherein the second processing path comprises a second set of processing blocks, wherein, responsive to a command to switch between the first mode of operation and the second mode of operation, the system is operative to adjust operating parameters of at least a subset of the first or second set of processing blocks over a slewing transition period.

### FIELD OF THE INVENTION

The present disclosure relates to a reconfigurable audio system.

### BACKGROUND

Devices such as desktop, laptop and tablet computers, mobile telephones and the like are typically used for multiple different purposes or tasks. For example, a user of a laptop may use it for video calling, gaming and playback of video and audio content such as films music, podcasts and the like, as well as routine tasks such as word processing and the like.

Different tasks require different audio processing. For example, for video calling it may be desirable to enhance spoken dialog to improve clarity and intelligibility of speech, whereas for playback of music it may be desirable to enhance stereo effects to engender in the user a perception of a soundstage that extends beyond the physical position of speakers of the device.

Thus, it may be necessary or desirable to apply different processing to audio signals in such a device, according to the task being performed or application being used.

### SUMMARY

According to a first aspect, the invention provides a reconfigurable audio system operable in a first mode of operation and a second mode of operation, the reconfigurable audio system comprising: a first processing path for processing a first signal to generate a first processed output signal, wherein the first processing path comprises a first set of processing blocks; and a second processing path for processing a second signal to generate a second processed output signal, wherein the second processing path comprises a second set of processing blocks, wherein, responsive to a command to switch between the first mode of operation and the second mode of operation, the system is operative to adjust operating parameters of at least a subset of the first or second set of processing blocks over a slewing transition period.

The reconfigurable audio system may further comprise a slewing block for controlling adjustment of the operating parameters of the subset of the first or second set of processing blocks.

The reconfigurable audio system may further comprise an encoder block for generating the first and second signals.

The first signal may be a mid channel signal. The second signal may be a side channel signal. The encoder block may be configured to generate the mid channel signal and the side channel signal from left channel and right channel stereo audio signals.

The reconfigurable audio system may further comprise a decoder block for generating output left channel and right channel audio signals from the first and second processed output signals.

The processing blocks of the first and second sets of processing blocks may comprise digital filters.

The digital filters may comprise infinite impulse response (IIR) filters.

The operating parameters may comprise filter coefficients.

The first processing path may comprise a first subset of processing blocks of a first type and a second subset of processing blocks of a second type.

The second processing path may comprise a first subset of processing blocks of a first type and a second subset of processing blocks of a second type.

The reconfigurable audio system may be operative, responsive to the command to switch between the first mode of operation and the second mode of operation, to adjust operating parameters of the second subset of processing blocks of the first or second processing path over the slewing transition period.

The reconfigurable audio system may further comprise: a first parallel processing path in parallel with the first subset of processing blocks of the first processing path; and a second parallel processing path in parallel with the first subset of processing blocks of the second processing path.

The first parallel processing path may comprise a first set of parallel processing blocks, for use in the second mode of operation, wherein the first set of parallel processing blocks are of a different configuration than the processing blocks of the first subset of processing blocks of the first processing path.

The second parallel processing path may comprise a second set of parallel processing blocks, for use in the second mode of operation, wherein the second set of parallel processing blocks are of a different configuration than the processing blocks of the first subset of processing blocks of the second processing path.

The reconfigurable audio system may further comprise: a first cross-fade block operable, responsive to the command to switch between the first mode of operation and the second mode of operation, to transition its output between an output signal of the first subset of processing blocks of the first processing path and an output signal of the first parallel processing path over a cross-fade transition period; and a second cross-fade block operable, responsive to the command to switch between the first mode of operation and the second mode of operation, to transition its output between an output signal of the first subset of processing blocks of the second processing path and an output signal of the second parallel processing path over the cross-fade transition period.

The reconfigurable audio system may further comprise: a first selector switch configured to selectively supply an input signal to the first subset of processing blocks of the first processing path or to the first parallel processing path; and a second selector switch configured to selectively supply an input signal to the first subset of processing blocks of the second processing path or to the second parallel processing path.

The first processing path and the second processing path may comprise an equal number of processing blocks.

According to a second aspect, the invention provides a digital signal processor (DSP) integrated circuit implementing the reconfigurable audio system of the first aspect.

According to a third aspect, the invention provides a host device comprising the reconfigurable audio system of the first aspect.

The host device may comprise, for example, a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.

According to a fourth aspect, the invention provides a reconfigurable audio system operable in a plurality of modes of operation, the reconfigurable audio system comprising: a first processing path for processing a first signal to generate a first processed output signal, wherein the first processing path comprises a reconfigurable processing module; a second processing path for processing a second signal to generate a second processed output signal, wherein the second processing path comprises a reconfigurable processing module; and a slewing block, wherein, responsive to a command to change between modes of operation, the slewing block is operative to slew operational parameters of the reconfigurable processing modules of the first and second processing paths to effect a change between modes of operation of the reconfigurable audio system.

According to a fifth aspect, the invention provides a reconfigurable audio system operable in a first mode of operation and a second mode of operation, the reconfigurable audio system comprising: a first processing path for processing a first signal, wherein the first processing path comprises a first set of processing blocks; a first parallel processing path for processing the first signal, wherein the first parallel processing path comprises a first set of parallel processing blocks; a second processing path for processing a second signal, wherein the second processing path comprises a second set of processing blocks; a second parallel processing path for processing the second signal, wherein the second processing path comprises a second set of parallel processing blocks; a first cross-fade block having a first input coupled to an output of the first processing path, a second input coupled to an output of the first parallel processing path and an output; and a second cross-fade block having a first input coupled to an output of the second processing path, a second input coupled to an output of the second parallel processing path and an output; wherein, responsive to a command to switch between the first mode of operation and the second mode of operation: the first cross-fade block is operative to transition its output between its first input and its second input over a cross-fade transition period; and the second cross-fade block is operative to transition its output between its first input and its second input over the cross-fade transition period.

According to a sixth aspect, the invention provides a reconfigurable audio system operable in a first mode of operation and a second mode of operation, the reconfigurable audio system comprising: a first processing path comprising; first and second parallel sets of processing blocks, wherein the first and second parallel sets of processing blocks are of a first type; a first cross-fade block coupled to outputs of the first and second parallel sets of processing blocks of the first processing path; and a third set of processing blocks coupled to an output of the first cross-fade block, wherein the third set of processing blocks of the first processing path are of a second type;
a second processing path comprising: first and second parallel sets of processing blocks, wherein the first and second parallel sets of processing blocks are of the first type; a second cross-fade block coupled to outputs of the first and second parallel sets of processing blocks of the second processing path; and a third set of processing blocks coupled to an output of the second cross-fade block, wherein the third set of processing blocks of the second processing path are of the second type; and a slewing block coupled to the third set of processing blocks of the first processing path and to the third set of processing blocks of the second processing path, wherein, responsive to a command to switch between the first mode of operation and the second mode of operation: the first cross-fade block is operative to transition its output between the output of the first set of parallel processing blocks and the output of the second set of parallel processing blocks of the first processing path over a cross-fade transition period; the second cross-fade block is operative to transition its output between the output of the first set of parallel processing blocks and the output of the second set of parallel processing blocks of the second processing path over the cross-fade transition period; and the slewing block is operative to slew operating parameters of the third set of processing blocks of the first processing path and to slew operating parameters of the third set of processing blocks of the second processing path over a slewing transition period.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic representation of a mid-side processing architecture for processing audio signals;

FIG. 2 is a schematic representation of an architecture for a stereo widening and dialog enhancement processing block of the mid-side processing architecture of FIG. 1;

FIG. 3 is a schematic representation of an architecture for the stereo widening and dialog enhancement processing block of the mid-side processing architecture of FIG. 1;

FIG. 4 is a schematic representation of an example architecture for a mid channel cross-fade block or module and a side channel cross-fade block or module used in the architecture of FIG. 3;

FIG. 5 is a schematic representation of an alternative architecture for the stereo widening and dialog enhancement processing block of the mid-side processing architecture of FIG. 1;

FIG. 6 is a schematic representation of an alternative architecture for the stereo widening and dialog enhancement processing block of the mid-side processing architecture of FIG. 1;

FIG. 7 is a schematic representation of example architectures for a mid channel processing path and a side channel processing path of the architecture of FIG. 6;

FIG. 8 is a schematic representation of an alternative architecture for the stereo widening and dialog enhancement processing block of the mid-side processing architecture of FIG. 1; and

FIG. 9 is a schematic representation of an alternative architecture for the stereo widening and dialog enhancement processing block of the mid-side processing architecture of FIG. 1.

### DETAILED DESCRIPTION

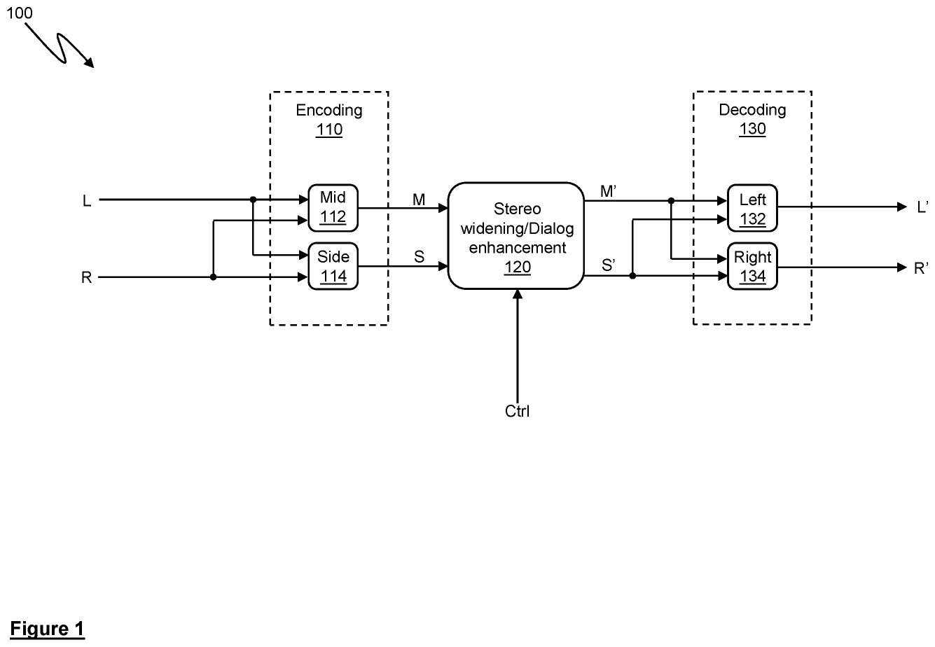

FIG. 1 is a schematic representation of a mid-side processing architecture for processing an audio signal, which may be used to apply stereo widening or dialog enhancement processing to an audio signal to generate an enhanced output audio signal.

As shown generally at 100 in FIG. 1, the mid-side processing architecture includes an encoding block 110, a stereo widening and dialog enhancement processing block 120 and a decoding block 130. These processing blocks may be implemented in software executed by a suitable processor (e.g. an applications processor) of a host device such as a desktop, laptop or tablet computer or mobile telephone. Alternatively, these processing blocks may be implemented in a digital signal processor (DSP) integrated circuit of the host device, e.g. as software executed by one or more hardware processing blocks or modules of the DSP.

The encoding block 110 is configured to receive left (L) and right (R) audio channel signals of an input stereo audio signal and to process these signals to generate and output mid (M) and side (S) channel mono output signals. The mid and side channel output signals are typically digital signals comprising one or more frames of digital audio data, with each frame comprising a predefined number of samples of digital audio data.

The encoding block 110 includes a mid channel signal generation sub-block 112, configured to sum the left and right audio channel signals to generate the mid channel output signal. The mid channel output signal represents audio content that is common to both the left and right audio channel signals, e.g. lead vocal or bass content.

The encoding block 110 further includes a side channel signal generation sub-block 114, configured to subtract the right channel audio signal from the left channel audio signal to generate the side channel output signal. The side channel output signal represents audio content that presents only in one side or the other, which contributes to a listener's perception of width and space in the audio, e.g. stereo effects or panned (left/right) instruments.

The mid and side channel output signals are output by the encoding block 110 to the stereo widening and dialog enhancement processing block 120, which is configured to operate in either a stereo widening mode to apply stereo widening processing or a dialog enhance mode to apply dialog enhancement processing, as required according to a task currently being performed or expected to be performed by the host device. The required processing may be indicated or signalled by a control signal Ctrl supplied to the mid-side processing architecture 100 (e.g. to the stereo widening and dialog enhancement processing block 120) from another part of the host device such as a main processor or an applications processor.

The stereo widening and dialog enhancement processing block 120 is configured to apply the required processing to the mid and side channel signals to generate a modified mid channel signal M′ and a modified side channel signal S′.

The modified mid and side channel signals are output by the stereo widening and dialog enhancement processing block 120 to the decoding block 130, which is configured to process these modified mid and side channel signals to convert them into modified left and right audio channel signals L′, R′, which can be output a downstream audio output stage.

The decoding block 130 includes a left channel generation sub-block 132, which is configured to sum the modified mid channel signal M′ and the modified side channel signal S′ and divide the result by two to generate the modified left channel signal L′. Alternatively, the encoding block 110 may divide the mid channel output signal M by two prior to outputting it to the stereo widening and dialog enhancement block 120. This is mathematically equivalent to dividing the result of the sum of the modified mid channel signal M′ and the modified side channel signal S′ by two. However, for a limited bit width DSP application, it may be preferable for this divide by two operation to be performed or implemented by the decoding block 130.

The decoding block 130 further includes a right channel generation sub-block 134, which is configured to subtract the modified side channel signal S′ from the modified mid channel signal M′ and divide the result by two to generate the modified right channel signal R′. Alternatively, the encoding block 110 may divide the side channel output signal S by two prior to outputting it to the stereo widening and dialog enhancement block 120. This is mathematically equivalent to dividing the result of the subtraction of the modified side channel signal S′ from the modified mid channel signal M′ by two. However, for a limited bit width DSP application, it may be preferable for this divide by two operation to be performed or implemented by the decoding block 130.

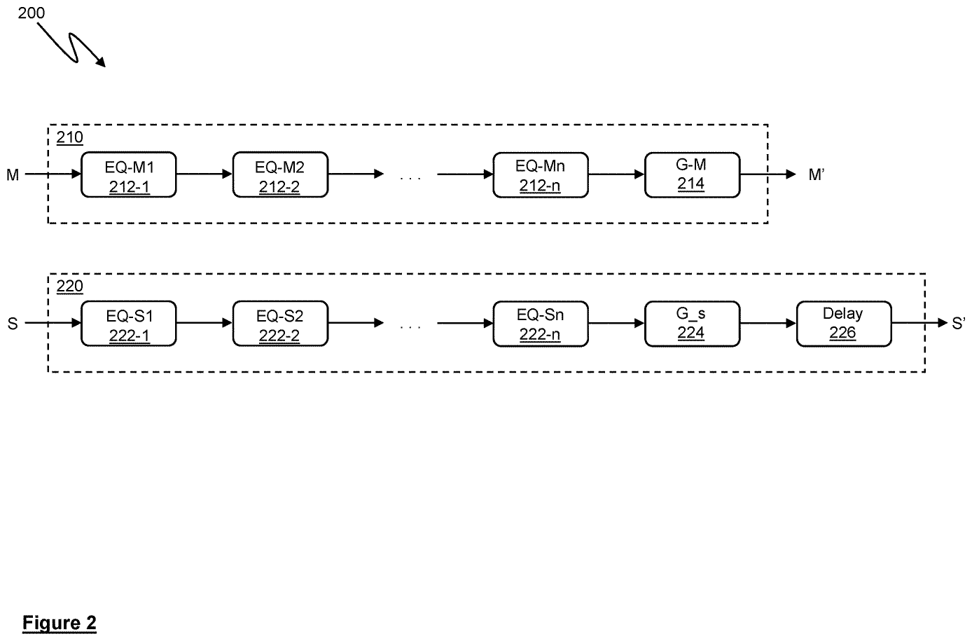

FIG. 2 is a schematic representation of an architecture for the stereo widening and dialog enhancement processing block 120 of the mid-side processing architecture 100 of FIG. 1.

This architecture, shown generally at 200 in FIG. 2, includes a mid channel processing path 210 and a side channel processing path 220.

The mid channel processing path 210 comprises a set of one or more reconfigurable mid channel processing blocks or modules.

In the illustrated example the mid channel processing path 210 includes first to nth equaliser blocks or modules 212-1, 212-2, 212-n, each configurable to bypass, amplify or attenuate one or more frequency bands of the mid channel signal M. It will be appreciated that more or fewer equaliser blocks or modules than are shown in FIG. 2 may be provided; the number of equaliser blocks or modules 212-1-212-n should be sufficient to meet the maximum demand for both stereo widening and dialog enhancement.

The equaliser blocks or modules 212-1-212n may be implemented, for example, as finite impulse response (FIR) or infinite impulse response (IIR) digital filters. IIR filters usually require fewer taps than FIR filters to achieve a given frequency response, so may require fewer processing resources and may thus minimise or at least reduce the processing overhead and/or power consumption of the stereo widening and dialog enhancement processing block 120.

The mid channel processing path 210 further includes a gain block or module 214 configurable to amplify or attenuate the signal in the mid channel processing path 210. In the example shown in FIG. 2, the gain block or module 214 is shown as a separate block or module from the equaliser blocks or modules 212-1-212n. This arrangement simplifies control and implementation of the mid channel processing path 210. However, in an alternative arrangement, the gain of the mid channel processing path 210 may be controlled without a separate gain block or module, by including a suitable gain term in configuration parameters (e.g. filter coefficients) for the equaliser blocks or modules 212-1-212n. This alternative arrangement may require fewer processing and memory resources than providing a separate gain block or module 214.

The side channel processing path 220 similarly comprises a set of one or more reconfigurable side channel processing blocks or modules.

In the illustrated example the side channel processing path 220 includes first to nth equaliser blocks or modules 222-1, 222-2, 222-n, each configurable to bypass, amplify or attenuate one or more frequency bands of the side channel signal S. It will be appreciated that more or fewer equaliser blocks or modules than are shown in FIG. 2 may be provided; the number of equaliser blocks or modules 222-1-222-n should be sufficient to meet the maximum demand for both stereo widening and dialog enhancement. It is beneficial for the number of equaliser blocks or modules 222-1-222-n in the side channel processing path 220 to be equal to the number of equaliser blocks or modules 212-1-212-n in the mid channel processing path 210, as this facilitates synchronisation and control between the mid channel processing path 210 and the side channel processing path 220.

Again, the equaliser blocks or modules 222-1-222-n may be implemented, for example, as finite impulse response (FIR) or infinite impulse response (IIR) digital filters. IIR filters may be preferred to minimise or at least reduce the processing overhead and/or power consumption of the stereo widening and dialog enhancement processing block 120.

The side channel processing path 220 further includes a gain block or module 224 configurable to amplify or attenuate the signal in the side channel processing path 220. In the example shown in FIG. 2, the gain block or module 224 is shown as a separate block or module from the equaliser blocks or modules 222-1-222n. This arrangement simplifies control and implementation of the side channel processing path 220. However, in an alternative arrangement, the gain of the side channel processing path 220 may be controlled without a separate gain block or module, by including a suitable gain term in configuration parameters (e.g. filter coefficients) for the equaliser blocks or modules 222-1-222n. This alternative arrangement may require fewer processing and memory resources than providing a separate gain block or module 224.

Additionally, the side channel processing path 220 may include a delay block or module 226 configured to implement a delay to the side channel signal in the side channel processing path 220. The delay block or module 226 may be implemented as a digital filter, for example. Adding delay to the side channel signal S may help to improve a listener's perception of space in output audio.

For dialog enhancement, improving the clarity of speech content in an audio signal is the primary requirement. Strong bass and stereo effects may detract from speech intelligibility.

Thus, in operation of the stereo widening and dialog enhancement processing block 120 in a dialog enhancement mode, the equaliser blocks or modules 212-1-212-n of the mid channel processing path 210 may be configured to attenuate unwanted frequencies and amplify or otherwise enhance desired frequency content.

For example, the equaliser block or module 212-1 may be configured as a high-pass filter to attenuate bass frequencies in the mid channel signal M. The equaliser block or module 212-2 may be configured as a peaking filter with a centre frequency of around 4 kHz, to enhance frequency content in the frequency range corresponding to that of speech. The equaliser block or module 212-n may be configured as a peaking filter with a centre frequency of around 10 kHz, to preserve acoustic information in the mid channel signal.

In the side channel processing path 220, the equaliser blocks or modules 222-1-222-n may be configured as all-pass filters, such that the content of the side channel signal S is not modified by the equaliser blocks or modules 222-1-222-n, but is affected by the latency of the equaliser blocks or modules 222-1-222-n. As the number of equaliser blocks or modules 222-1-222-n of the side channel processing path 220 is equal to the number of equaliser blocks or modules 212-1-212-n of the mid channel processing path 210, a latency or delay of the side channel processing path 220 corresponds to a latency or delay of the mid channel processing path 210, such that the modified side channel signal S′ output by the side channel processing path 220 is synchronised with the modified mid channel signal M′ output by the mid channel processing path 210.

Additionally, the gain block or module 224 of the side channel processing path 220 may be configured to attenuate the side channel signal S, to reduce stereo effects.

In contrast, for stereo widening, enhancing stereo effects is the primary requirement.

Thus, in operation of the stereo widening and dialog enhancement processing block 120 in a stereo widening mode, the equaliser blocks or modules 222-1-222-n of the side channel processing path 220 may be configured to amplify or otherwise enhance higher frequency content in the side channel signal S to improve the perceptibility, to a listener, of stereo effects.

For example, the equaliser blocks or modules 222-1, 222-2 may be configured as high-pass or shelf filters. The gain block or module 224 may be configured to amplify the side channel signal S.

In the mid channel processing path 210, the equaliser blocks or modules 212-1-212-n may all be configured as all-pass filters, such that the mid channel signal is not modified by the equaliser blocks or modules 212-1-212-n, but is affected by their latency, such that the modified mid channel signal M′ output by the mid channel processing path 210 is synchronised with the modified side channel signal S′ output by the side channel processing path 220.

As will be apparent from the foregoing discussion, the configuration of the processing blocks or modules of the mid channel processing path 210 and the side channel processing path 220 is different in the stereo widening mode than in the dialog enhancement mode. Switching directly between these different configurations when the mode of operation of the stereo widening and dialog enhancement processing block 120 or its host device changes may introduce audible artefacts and/or distortion as a result of instantaneous changes to the configuration of the equaliser blocks or modules in the mid channel processing path 210 and the side channel processing path 220, such as changing filter coefficients. Such audible artefacts and distortion are undesirable.

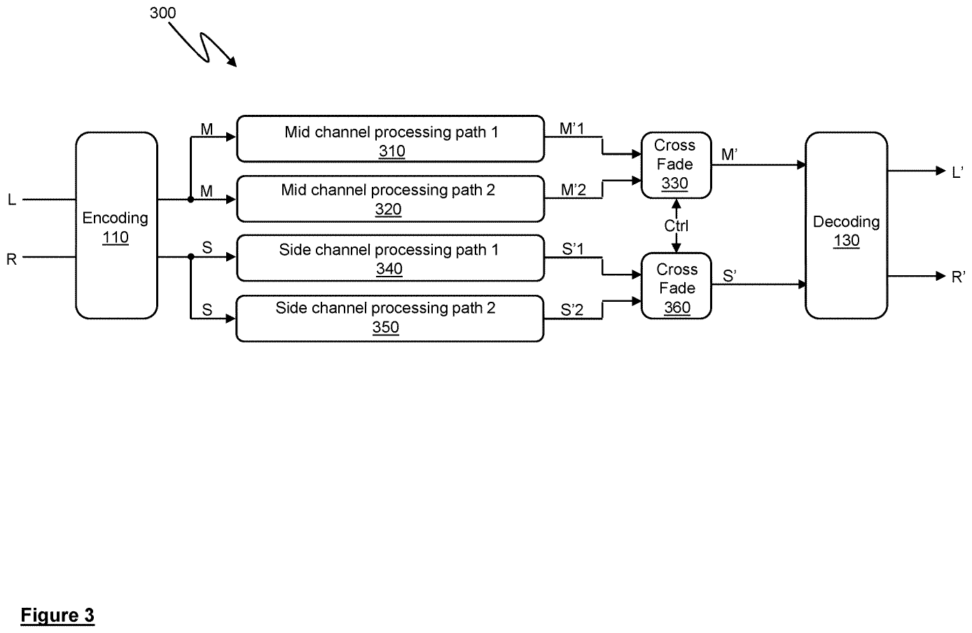

FIG. 3 is a schematic representation of an architecture for the stereo widening and dialog enhancement processing block 120 of the mid-side processing architecture 100 of FIG. 1, which enables switching between dialog enhancement and stereo widening modes that minimises or at least reduces audible artefacts and distortion, as compared to the architecture shown in FIG. 2.

The architecture shown generally at 300 in FIG. 3 includes first and second mid channel processing paths 310, 320, a mid channel cross-fade block or module 330, first and second side channel processing paths 340, 350 and a side channel cross-fade block or module 360.

The first mid channel processing path 310 includes a first set of set of one or more mid channel processing blocks or modules, which may include one or more equaliser blocks or modules and a gain block or modules of the kind described above with reference to the mid channel processing path 210 of FIG. 2. The first mid channel processing path 310 differs from the mid channel processing path 210 of FIG. 2 in that its constituent processing blocks or modules are not configurable, but instead have a predefined fixed configuration. The processing blocks or modules may be configured for stereo widening, e.g. with all the equaliser blocks or modules configured as all-pass filters, as described above with reference to FIG. 2.

The second mid channel processing path 320 includes a second set of one or more mid channel processing blocks or modules, which may include one or more equaliser blocks or modules and a gain block or module of the kind described above with reference to the mid channel processing path 210 of FIG. 2. Again, however, the second mid channel processing path 320 differs from the mid channel processing path 210 of FIG. 2 in that its constituent processing blocks or modules are not configurable, but instead have a predefined fixed configuration. The processing blocks or modules may be configured for dialog enhancement, to attenuate unwanted frequencies and amplify or otherwise enhance desired frequency content, as described above with reference to FIG. 2.

Inputs of the first and second mid channel processing paths 310, 320 are coupled to an output of an encoding block or module 110 (of the kind described above with reference to FIG. 1) so as to receive the mid channel signal M from the encoding block 110. The first mid channel processing block 310 is configured to process the mid channel signal M to generate a first modified mid channel signal M′1, while the second mid channel processing block 320 is configured to process the mid channel signal M to generate a second modified mid channel signal M′2.

Outputs of the first and second mid channel processing paths 310, 320 are coupled to respective inputs of the mid channel cross-fade block or module 330. An output of the mid channel cross-fade block or module 330 is coupled to an input of a decoding block 130 (of the kind described above with reference to FIG. 1).

The first side channel processing path 340 includes a first set of set of one or more side channel processing blocks or modules, which may include one or more equaliser blocks or modules, a gain module or block and a delay module or block of the kind described above with reference to the side channel processing path 220 of FIG. 2. The first side channel processing path 340 differs from the side channel processing path 220 of FIG. 2 in that its constituent processing blocks or modules are not configurable, but instead have a predefined fixed configuration. The processing blocks or modules may be configured for stereo widening, e.g. with equaliser blocks or modules configured as high-pass or shelf filters and the gain block or module configured to amplify the side channel signal S, as described above with reference to FIG. 2.

The second side channel processing path 350 includes a second set of one or more side channel processing blocks or modules, which may include one or more equaliser blocks or modules, a gain module or block and a delay block or module of the kind described above with reference to the side channel processing path 220 of FIG. 2. Again, however, the second side channel processing path 350 differs from the side channel processing path 220 of FIG. 2 in that its constituent processing blocks or modules are not configurable, but instead have a predefined fixed configuration. The processing blocks or modules may be configured for dialog enhancement, e.g. with all the equaliser blocks or modules configured as all-pass filters, as described above with reference to FIG. 2.

Inputs of the first and second side channel processing paths 340, 350 are coupled to an output of the encoding block or module 110 so as to receive the side channel signal S from the encoding block 110. The first side channel processing path 340 is configured to process the side channel signal S to generate a first modified side channel signal S′1, while the second side channel processing path 350 is configured to process the side channel signal S to generate a second modified side channel signal S′2.

Outputs of the first and second side channel processing paths 340, 350 are coupled to respective inputs of the side channel cross-fade block or module 360. An output of the side channel cross-fade block or module 360 is coupled to an input of the decoding block 130.

The first and second mid channel processing paths 310, 320 are always on, such that they operate in parallel to process the mid channel signal M. The output of either the first mid channel processing path 310 or the second mid channel processing path 320 is selected by the mid channel cross-fade block or module 330 according to a required mode of operation for output to the decoding block 130 as a modified mid channel signal M′. Similarly, the first and second side channel processing paths 340, 350 are always on, such that they operate in parallel to process the side channel signal S. The output of either the first side channel processing path 340 or the second side channel processing path 350 is selected by the side channel cross-fade block or module 360 according to the required mode of operation for output to the decoding block or module 130 as a modified side channel signal S′.

The mid channel cross-fade block or module 330 and the side channel cross-fade block or module 360 each receive a control signal Ctrl indicating a required mode of operation (dialog enhancement or stereo widening). Responsive to this control signal, the mid channel cross-fade block or module 330 progressively switches, over a defined period of time, from one of the first and second mid channel processing paths 310, 320 to the other. Similarly, responsive to the control signal, the side channel cross-fade block or module 360 progressively switches, over a defined period of time, from one of the first and second side channel processing paths 340, 350 to the other.

Thus, if the architecture 300 is operating in the stereo widening mode, the mid channel cross-fade block or module 330 selects the first modified mid channel signal M′1 as the modified mid channel signal M′ to output to the decoding block 130, and the side channel cross-fade block or module 360 selects the first modified side channel signal S′1 as the modified side channel signal S′ to output to the decoding block or module 130.

Responsive to a control signal Ctrl indicating that a switch to the dialog enhance mode is required, the mid channel cross-fade block or module 330 progressively transitions from outputting the first modified mid channel signal M′1 to outputting the second modified mid channel signal M′2 over a predefined transition time, by attenuating the first modified mid channel signal M′1 from a maximum signal level to zero over the predefined transition time, while amplifying the second modified mid channel signal M′2 from zero to a maximum signal level over the predefined transition time.

Similarly, responsive to the control signal Ctrl indicating that a switch to the dialog enhance mode is required, the side channel cross-fade block or module 360 progressively transitions from outputting the first modified side channel signal S′1 to outputting the second modified side channel signal S′2 over the predefined transition time, by attenuating the first modified side channel signal S′1 from a maximum signal level to zero over the predefined transition time, while amplifying the second modified side channel signal S′2 from zero to a maximum signal level over the predefined transition time.

Conversely, if the architecture 300 is operating in the dialog enhance mode, responsive to a control signal Ctrl indicating that a switch to the stereo widening mode is received, the mid channel cross-fade block or module 330 progressively transitions from outputting the second modified mid channel signal M′2 to outputting the first modified mid channel signal M′1 over the predefined transition time, by attenuating the second modified mid channel signal M′1 from a maximum signal level to zero over the predefined transition time, while amplifying the first modified mid channel signal M′1 from zero to a maximum signal level over the predefined transition time.

Similarly, responsive to the control signal Ctrl indicating that a switch to the stereo widening mode is required, the side channel cross-fade block or module 360 progressively transitions from outputting the second modified side channel signal S′2 to outputting the first modified side channel signal S′1 over the predefined transition time, by attenuating the second modified side channel signal S′2 from a maximum signal level to zero over the predefined transition time, while amplifying the first modified side channel signal S′1 from zero to a maximum signal level over the predefined transition time.

The use of always-on parallel first and second mid channel processing paths 310, 320 and always-on parallel first and second side channel processing paths 340, 350 obviates the need for dynamic reconfiguration of processing blocks or modules (e.g. equaliser blocks or modules). Cross-fading the respective outputs of the first and second mid channel processing paths 310, 320 and the first and second side channel processing paths 340, 350 in response to a control signal Ctrl indicating that a change in the operating mode of the architecture is required eliminates or at least reduces audible artefacts and distortion arising from the change between modes, as there is no instantaneous change in the configuration of either the mid channel processing path or the side channel processing path. Instead, the architecture 300 of FIG. 3 smoothly transitions between the respective first and second mid channel processing paths 310, 320 and the first and second side channel processing paths 340, 350 over the predefined transition time.

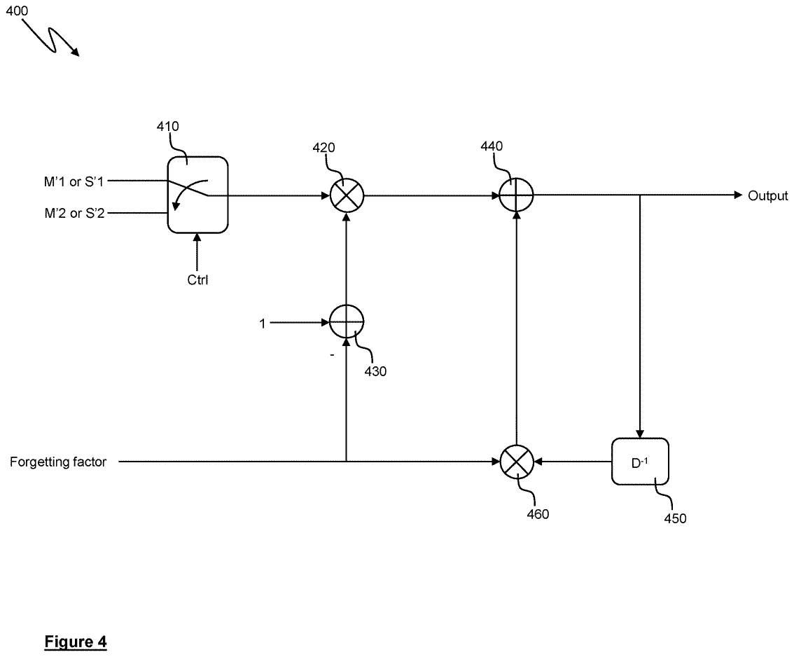

FIG. 4 is a schematic representation of an example architecture for the mid channel cross-fade block or module 330 and the side channel cross-fade block or module 360.

As shown generally at 400 in FIG. 4, a cross-fade architecture 400 may be implemented using recursive filtering. The example cross-fade architecture 400 of FIG. 4 includes a switch 410 for selecting between first and second input signals (e.g. the first and second modified mid channel signals M′1, M′2 output by the first and second mid channel processing paths 310, 320, or the first and second modified side channel signals S′1, S′2 output by the first and second side channel processing paths 340, 350 of the architecture 300 of FIG. 3). The switch 410 receives the control signal Ctrl and selects between the input signals based on the control signal Ctrl.

The selected input signal is output to a first input of a first multiplier 420. A second input of the first multiplier 420 is coupled to an output of a subtractor 430. The subtractor receives a signal indicative of a constant value of 1 at a first input, and a signal indicative of a forgetting factor at its second input, and outputs a signal indicative of the result of (1—the forgetting factor) to the second input of the first multiplier 420.

The first multiplier 420 thus outputs a signal indicative of the product of the selected input signal with (1—the forgetting factor) to a first input of an adder 440. An output of the adder 440 is coupled to an output of the architecture 400, and also to an input of a delay element 450. The delay element is configured to output a version of the signal output by the adder 440, delayed by one frame. An output of the delay element 450 is coupled to a first input of a second multiplier 460. A second input of the second multiplier 460 receives the signal indicative of the forgetting factor, such that the second multiplier 460 outputs a signal indicative of the product of a delayed version of the output signal and the forgetting factor. The output of the second multiplier 460 is coupled to a second input of the adder.

The transition time of the cross-fade architecture 400 is determined by the forgetting factor. The forgetting factor can be defined as

$$forgetting factor = {e}^{\frac{- 1 / \frac{fs}{N}}{t / 2.2}} ,$$

where fs is the sampling frequency in Hz of the input signal, N is the number of samples in one frame, and t is the transition time in seconds.

Running parallel always-on mid channel and side channel processing paths increases the power consumption and use of processing resource of the architecture 300, in comparison with the architecture 200 of FIG. 2.

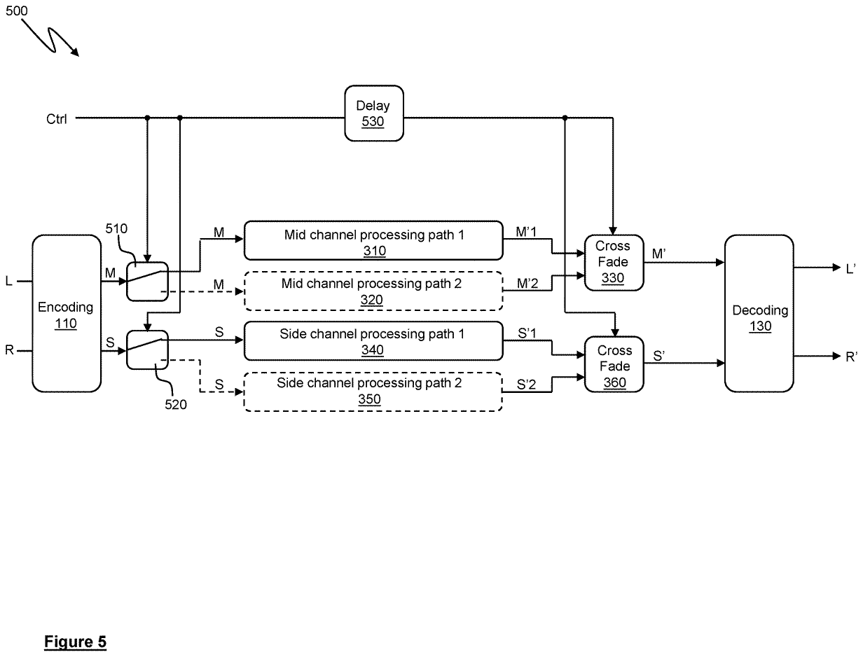

FIG. 5 is a schematic representation of an alternative architecture for the stereo widening and dialog enhancement processing block 120 of the mid-side processing architecture 100 of FIG. 1.

As shown generally at 500 in FIG. 5, this alternative architecture is similar to the architecture 300 described above with reference to FIG. 3, in that it includes first and second mid channel processing paths 310, 320, a mid channel cross-fade block or module 330, first and second side channel processing paths 340, 350 and a side channel cross-fade block or module 360. These elements of the architecture 500 are identical in construction and operation to the correspondingly numbered elements of the architecture 300 so will not be described again in detail here.

The architecture 500 also includes a first selector switch 510 coupled between a first output of the encoding block 110 and the inputs of the first and second mid channel processing paths 310, 320, for selectively coupling the first output of the encoding block 110 to either or both the first or second mid channel processing path 310, 320. The architecture 500 similarly includes a second selector switch 520 coupled between a second output of the processing block 110 the first and second side channel processing paths 340, 350, for selectively coupling the second output of the encoding block 110 to either or both the first or second side channel processing path 340, 350.

The architecture 500 further includes a reconfigurable delay block or module 530, configured to receive a control signal Ctrl indicative of a required mode of operation of the architecture 500 and to output a delayed version of the control signal Ctrl to the mid channel cross-fade block or module 330 and the side channel cross-fade block or modules 360.

The architecture 500 differs from the architecture 300 in that the first and second mid channel processing paths 310, 320 and the first and second side channel processing paths 340, 350 are not always-on, but are instead selectively activated or enabled in response to the control signal Ctrl.

For example, if stereo widening mode is a default mode of operation of the architecture 500, the first mid channel processing path 310 and the first side channel processing path 340 are usually enabled or activated, and the second mid channel processing path 320 and the second side channel processing path 350 are usually disabled or deactivated. The first selector switch 510 couples the first output of the encoding block 110 to the first mid channel processing path 310, such that the first mid channel processing path 310 receives the mid channel signal M output by the encoding block 110. The second selector switch 520 couples the second output of the encoding block 110 to the first side channel processing path 340, such that the second side channel processing path receives the side channel signal S output by the encoding block 110.

Responsive to receiving a control signal Ctrl indicating that the architecture 500 is required to switch to a dialog enhancement mode of operation, the second mid channel processing path 320 and the second side channel processing path 350 are enabled or activated.

The first selector switch 510 couples the first output of the encoding block 110 to the second mid channel processing path 320, while continuing to couple the first output of the encoding block 110 to the first mid channel processing path 310, such that both the first and second mid channel processing paths 310, 320 receive the mid channel signal M output by the encoding block 110.

The second selector switch 520 similarly couples the second output of the encoding block 110 to the second side channel processing path 350, which continuing to couple the second output of the encoding block 110 to the first side channel processing path 340, such that both the first and second side channel processing paths 340, 350 receive the side channel signal S output by the encoding block 110.

Following activation or enabling of the second mid channel processing path 320, the processing blocks or modules of that path, particularly any equaliser blocks or modules, will require some time to converge from previous states before the second mid channel processing path 320 can begin processing the mid channel signal M correctly. Similarly, following activation or enabling of the second side channel processing path 350, the processing blocks or modules of that path, particularly any equaliser blocks or modules, will require some time to converge from previous states before the second side channel processing path 350 can begin processing the side channel signal S correctly.

To accommodate the required convergence time of the processing blocks or modules of the second mid channel processing path 320 and the second side channel processing path 350, the delay block or module 530 applies a delay to the control signal Ctrl, of sufficient duration to allow the processing blocks or modules to converge. After this delay period has elapsed, the control signal Ctrl is supplied to the mid channel cross-fade block or module 330 and to the side channel cross-fade block or module 360, which cross-fade the modified mid channel signals M′1, M′2 and side channel signals S′1, S′2, respectively, over the predefined transition time as described above with reference to FIG. 3, to effect a smooth transition from the stereo widening mode of operation to the dialog enhance mode of operation of the architecture 500.

The total time to switch from the stereo widening mode to the dialog enhance mode is thus the sum of the convergence time of the processing modules of the second mid channel processing path 320 and the second side channel processing path 350 and the transition time of the cross-fade blocks or modules 330, 360.

After the transition from the stereo widening mode to the dialog enhance mode has been completed (e.g. after the transition time of the cross-fade blocks or modules 330, 360 has elapsed), the first selector switch 510 decouples the first mid channel processing path 310 from the first output of the encoding block 110, while continuing to couple the first output of the encoding block 110 to the second mid channel processing path 320, such that only the second mid channel processing path 320 receives the mid channel signal M output by the encoding block 110. Internal states of the processing blocks or modules of the first mid channel processing path 310 are frozen, and the first mid channel processing path 310 is deactivated or disabled.

The second selector switch 520 similarly decouples the first side channel processing path 340 from the second output of the encoding block 110, while continuing to couple the second output of the encoding block 110 to the second side channel processing path 350, such that only the second side channel processing path 350 receives the side channel signal S output by the encoding block 110. Internal states of the processing blocks or modules of the first side channel processing path 340 are frozen, and the first side channel processing path 340 is deactivated or disabled.

Responsive to a control signal Ctrl indicating that a switch from the dialog enhance mode to the stereo widening mode of the architecture 500 is required, the first mid channel processing path 310 and the first side channel processing path 340 are enabled or activated.

The first selector switch 510 couples the first output of the encoding block 110 to the first mid channel processing path 310, while continuing to couple the first output of the encoding block 110 to the second mid channel processing path 320, such that both the first and second mid channel processing paths 310, 320 receive the mid channel signal M output by the encoding block 110.

The second selector switch 520 similarly couples the second output of the encoding block 110 to the first side channel processing path 340, which continuing to couple the second output of the encoding block 110 to the second side channel processing path 350, such that both the first and second side channel processing paths 340, 350 receive the side channel signal S output by the encoding block 110.

Following activation or enabling of the first mid channel processing path 310, the processing blocks or modules of that path, particularly any equaliser blocks or modules, will require some time to converge from previous states before the first mid channel processing path 310 can begin processing the mid channel signal M correctly. Similarly, following activation or enabling of the first side channel processing path 340, the processing blocks or modules of that path, particularly any equaliser blocks or modules, will require some time to converge from previous states before the first side channel processing path 340 can begin processing the side channel signal S correctly.

Again, to accommodate the required convergence time of the processing blocks or modules of the first mid channel processing path 310 and the first side channel processing path 340, the delay block or module 530 applies a delay to the control signal Ctrl, of sufficient duration to allow the processing blocks or modules to converge. After this delay period has elapsed, the control signal Ctrl is supplied to the mid channel cross-fade block or module 330 and to the side channel cross-fade block or module 360, which cross-fade the modified mid channel signals M′1, M′2 and side channel signals S′1, S′2, respectively, over the predefined transition time as described above with reference to FIG. 3, to effect a smooth transition from the dialog enhance mode of operation to the stereo widening mode of operation of the architecture 500.

Again, the total time to switch from the dialog enhance mode to the stereo widening mode is the sum of the convergence time of the processing modules of the first mid channel processing path 310 and the first side channel processing path 340 and the transition time of the cross-fade blocks or modules 330, 360.

After the transition from the dialog enhance mode to the stereo widening mode has been completed (e.g. after the transition time of the cross-fade blocks or modules 330, 360 has elapsed), the first selector switch 510 decouples the second mid channel processing path 320 from the first output of the encoding block 110, while continuing to couple the first output of the encoding block 110 to the first mid channel processing path 310, such that only the first mid channel processing path 310 receives the mid channel signal M output by the encoding block 110. Internal states of the processing blocks or modules of the second mid channel processing path 320 are frozen, and the second mid channel processing path 320 is deactivated or disabled.

The second selector switch 520 similarly decouples the second side channel processing path 350 from the second output of the encoding block 110, while continuing to couple the second output of the encoding block 110 to the first side channel processing path 340, such that only the first side channel processing path 340 receives the side channel signal S output by the encoding block 110. Internal states of the processing blocks or modules of the second side channel processing path 340 are frozen, and the second side channel processing path 350 is deactivated or disabled.

Thus, in normal operation of the architecture 500 in either the stereo widening mode or the dialog enhance mode, only one of the first and second mid channel processing paths 310, 320 is enabled or activated, and only one of the first and second side channel processing paths 340, 350 is enabled or activated. This may reduce the power consumption and use of processing resource of the architecture 500, in comparison with the architecture 300 of FIG. 3. However, during transitions between the modes of operation, power consumption and use of processing resource increases to the same level as in the architecture 300 of FIG. 3 in the periods in which both the first and second mid channel processing paths 310, 320 and both the first and second side channel processing paths 340, 350 are enabled or activated. Additionally, the memory required for storage of configuration parameters for the processing blocks or modules, e.g. filter coefficients, is the same as in the architecture 300 of FIG. 3.

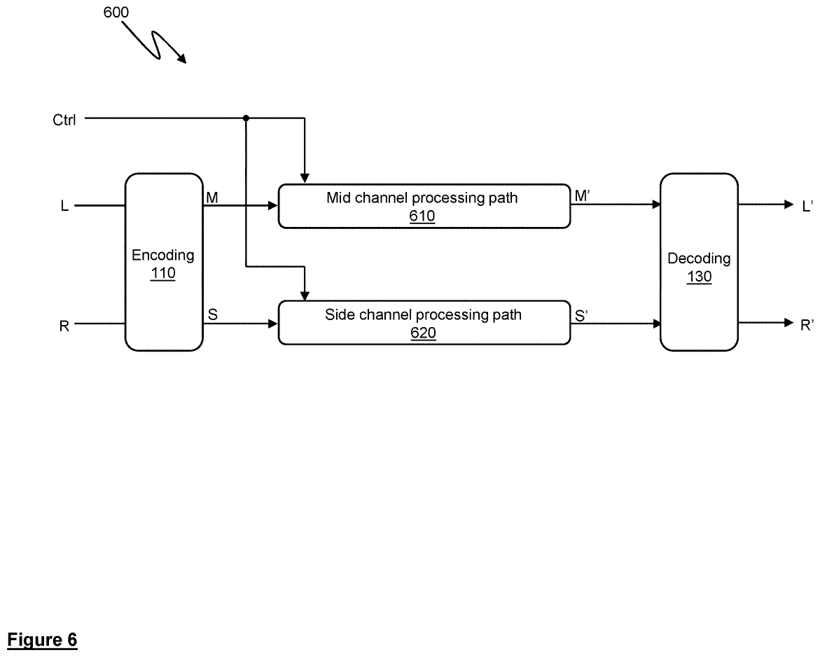

FIG. 6 is a schematic representation of an alternative architecture for the stereo widening and dialog enhancement processing block 120 of the mid-side processing architecture 100 of FIG. 1.

The architecture shown generally at 600 in FIG. 6 comprises a single mid channel processing path 610 and a single side channel processing path 620.

The mid channel processing path 610 receives a mid channel signal M from an encoding block 110 (of the kind described above with reference to FIG. 1) and outputs a modified mid channel signal M′ to a decoding block 130 (of the kind described above with reference to FIG. 1). The side channel processing path 620 receives a side channel signal S from the encoding block 110 and outputs a modified side channel signal S′ to the decoding block 130.

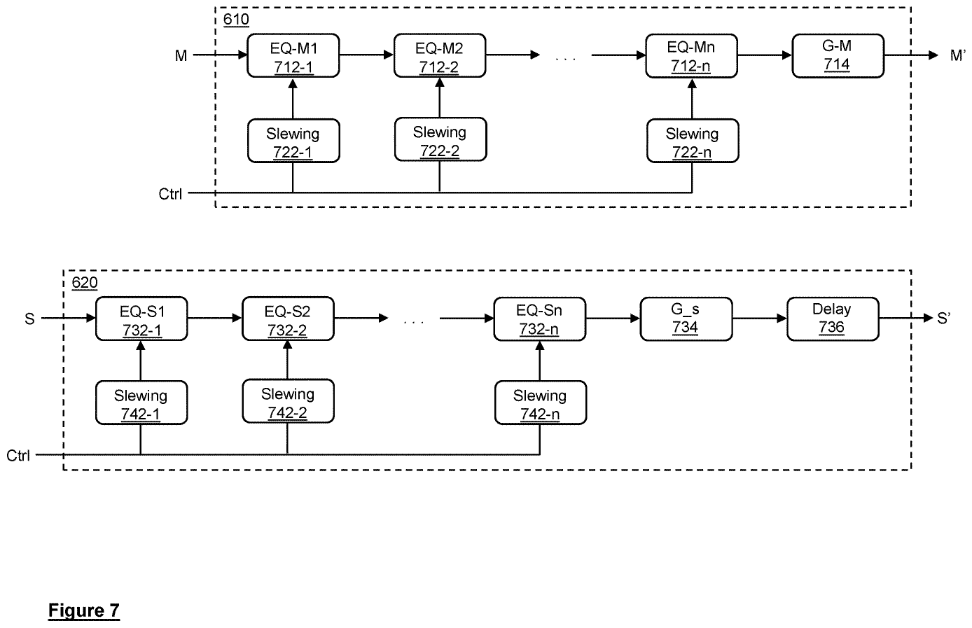

FIG. 7 is a schematic representation of example architectures for the mid channel processing path 610 and the side channel processing path 620 of the architecture 600 of FIG. 6.

The mid channel processing path 610 comprises a set of one or more reconfigurable mid channel processing blocks or modules.

In the illustrated example the mid channel processing path 610 includes first to nth equaliser blocks or modules 712-1-712-n, each configurable to bypass, amplify or attenuate one or more frequency bands of the mid channel signal M. It will be appreciated that more or fewer equaliser blocks or modules 712-1-712-n than are shown in FIG. 7 may be provided; the number of equaliser blocks or modules should be sufficient to meet the maximum demand for both stereo widening and dialog enhancement.

The equaliser blocks or modules 712-1-712-n may be implemented, for example, as finite impulse response (FIR) or infinite impulse response (IIR) digital filters. IIR filters usually require fewer taps than FIR filters to achieve a given frequency response, so may require fewer processing resources and may thus minimise or at least reduce the processing overhead and/or power consumption of the mid channel processing path 610.

The mid channel processing path 610 further includes first to nth slewing blocks or modules 722-1-722-n, each associated with a respective one of the equaliser blocks or modules 712-1-712-n.

The slewing blocks or modules 722-1-722-n are configured to control slewing of operational parameters such as filter coefficients of their associated equaliser blocks or modules 712-1-712-n (i.e. adjustment of the operational parameters over a transition period) to effect a transition between modes of operation of the architecture 600.

The mid channel processing path 610 further includes a gain block or module 714 configurable to amplify or attenuate the signal in the mid channel processing path 710. In the example shown in FIG. 7, the gain block or module 714 is shown as a separate block or module from the equaliser blocks or modules 712-1-712n. This arrangement simplifies control and implementation of the mid channel processing path 610. However, in an alternative arrangement, the gain of the mid channel processing path 610 may be controlled without a separate gain block or module, by including a suitable gain term in configuration parameters (e.g. filter coefficients) for the equaliser blocks or modules 712-1-712n. This alternative arrangement may require fewer processing and memory resources than providing a separate gain block or module 714.

The side channel processing path 620 similarly comprises a set of one or more reconfigurable side channel processing blocks or modules.

In the illustrated example the side channel processing path 620 includes first to nth equaliser blocks or modules 732-1-732-n, each configurable to bypass, amplify or attenuate one or more frequency bands of the side channel signal S. It will be appreciated that more or fewer equaliser blocks or modules 732-1-732-n than are shown in FIG. 7 may be provided; the number of equaliser blocks or modules should be sufficient to meet the maximum demand for both stereo widening and dialog enhancement. It is beneficial for the number of equaliser blocks or modules 732-1-732-n in the side channel processing path 620 to be equal to the number of equaliser blocks or modules 712-1-712-n in the mid channel processing path 610, as this facilitates synchronisation and control between the mid channel processing path 610 and the side channel processing path 620.

Again, the equaliser blocks or modules 732-1-732-n may be implemented, for example, as finite impulse response (FIR) or infinite impulse response (IIR) digital filters. IIR filters may be preferred to minimise or at least reduce the processing overhead and/or power consumption of the side channel processing path 620.

The side channel processing path 620 further includes first to nth slewing blocks or modules 742-1-742-n, each associated with a respective one of the equaliser blocks or modules 742-1-742-n.

The slewing blocks or modules 742-1-742-n are configured to control slewing of operational parameters such as filter coefficients of their associated equaliser blocks or modules 732-1-732-n (i.e. adjustment of the operational parameters over a transition period) to effect a transition between modes of operation of the architecture 600.

The side channel processing path 620 further includes a gain block or module 734 configurable to amplify or attenuate the signal in the side channel processing path 620. In the example shown in FIG. 7, the gain block or module 734 is shown as a separate block or module from the equaliser blocks or modules 732-1-732n. This arrangement simplifies control and implementation of the side channel processing path 620. However, in an alternative arrangement, the gain of the side channel processing path 620 may be controlled without a separate gain block or module, by including a suitable gain term in configuration parameters (e.g. filter coefficients) for the equaliser blocks or modules 732-1-732n. This alternative arrangement may require fewer processing and memory resources than providing a separate gain block or module 734.

Additionally, the side channel processing path 620 may include a delay block or module 736 configured to implement a delay to the side channel signal in the side channel processing path 620. The delay block or module 736 may be implemented as a digital filter, for example. Adding delay to the side channel signal S may help to improve a listener's perception of space in output audio.

In operation of the architecture 600 of FIG. 6 in a stereo widening mode, the processing blocks or modules 712-1-712-n, 714 of the mid channel processing path 610 are in a first configuration for stereo widening. For example, in the first configuration the equaliser blocks or modules 712-1-712-n may all be configured as all-pass filters, such that the mid channel signal M is not modified by the equaliser blocks or modules 712-1-712-n, but is affected by their latency, such that the modified mid channel signal M′ output by the mid channel processing path 610 is synchronised with the modified side channel signal S′ output by the side channel processing path 620.

The processing blocks or modules 732-1-732-n, 734, 736 of the side channel processing path 620 are also in a first configuration for stereo widening. For example, in the first configuration the equaliser blocks or modules 722-1, 722-2 may be configured as high-pass or shelf filters and the gain block or module 724 may be configured to amplify the side channel signal S.

Responsive to receiving a control signal Ctrl indicating that a change to a dialog enhance mode of operation is required, the slewing blocks or modules 722-1-722-n of the mid channel processing path 610 reconfigure their associated equaliser blocks or modules 712-1-712-n, over a transition period, from the first configuration to a second configuration for dialog enhancement. For example, in the second configuration the equaliser block or module 712-1 may be configured as a high-pass filter to attenuate bass frequencies in the mid channel signal M. The equaliser block or module 712-2 may be configured as a peaking filter with a centre frequency of around 4 kHz, to enhance frequency content in the frequency range corresponding to that of speech. The equaliser block or module 712-n may be configured as a peaking filter with a centre frequency of around 10 kHz, to preserve acoustic information in the mid channel signal M.

To achieve this reconfiguration of the mid channel processing path 610, each slewing block or module 722-1-722-n is operative to progressively adjust, over the transition period, operational parameters such as filter coefficients of its associated equaliser block or module 712-1-712-n such that at the end of the transition period the equaliser blocks or modules 712-1-712-n of the mid channel processing path have adopted the second configuration for dialog enhancement.

Similarly, responsive to receiving the control signal Ctrl indicating that a change to a dialog enhance mode of operation is required, the slewing blocks or modules 742-1-742-n of the side channel processing path 620 reconfigure their associated equaliser blocks or modules 732-1-732-n, over the transition period, from the first configuration to a second configuration for dialog enhancement. For example, in the second configuration the equaliser blocks or modules 732-1-732-n may be configured as all-pass filters, such that the content of the side channel signal S is not modified by the equaliser blocks or modules 732-1-732-n, but is affected by the latency of the equaliser blocks or modules 732-1-732-n.

To achieve this reconfiguration of the side channel processing path 620, each slewing block or module 742-1-742-n is operative to progressively adjust, over the transition period, operational parameters such as filter coefficients of its associated equaliser block or module 732-1-732-n such that at the end of the transition period the equaliser blocks or modules 732-1-732-n of the side channel processing path have adopted the second configuration for dialog enhancement.

Similarly, responsive to receiving a control signal Ctrl indicating that a change from dialog enhance mode to stereo widening mode is required, the slewing blocks or modules 722-1-722-n, 742-1-742-n of the mid channel processing path 610 and the side channel processing path 620, respectively, are operative to progressively adjust, over the transition period, operational parameters such as filter coefficients of their associated equaliser blocks or modules 712-1-712-n, 731-1-731-n such that at the end of the transition period the equaliser blocks or modules 712-1-712-n of the mid channel processing path 610 and the equaliser blocks or modules 731-1-731-n of the side channel processing path 620 have adopted the first configuration for stereo widening.

Techniques for slewing the operational parameters (e.g. filter coefficients) of the equaliser blocks or modules 712-1-712-n, 732-1-732-n of the mid channel processing path 610 and the side channel processing path 620 will be familiar to those of ordinary skill in the art. For example, the operational parameters (e.g. filter coefficients) may be slewed (adjusted) between the first configuration and the second configuration in a number of discrete steps over the transition period.

The architecture 600 of FIG. 6 requires only a single mid channel processing path 610 and a single side channel processing path 620, and no cross-fade blocks or modules are necessary. Thus, the computational resources required to implement the architecture 600 of FIG. 6 are reduced in comparison to the architectures 300, 500 of FIGS. 3 and 5. Memory usage is also reduced, in comparison to the architectures 300, 500, as internal instates of the equaliser blocks or modules in the second mid channel path and the second side channel path of the architecture 300 and 500 are not necessary. However, it is still necessary to pre-store both stereo widening and dialog enhance filter coefficient, as in the architectures 300 and 500.

In operation of the architecture 600 of FIG. 6, the operational parameters (e.g. filter coefficients) of all the equaliser blocks or modules 712-1-712-n, 731-1-731-n should not slewed at the same time, as this may lead to instability and/or introduction or audible artefacts or distortion, particularly where the slewing of the operational parameters of an equaliser block or module leads to a change in a type of filter implemented by that equaliser block or module, such as a change from an all-pass filter to a high-pass filter.

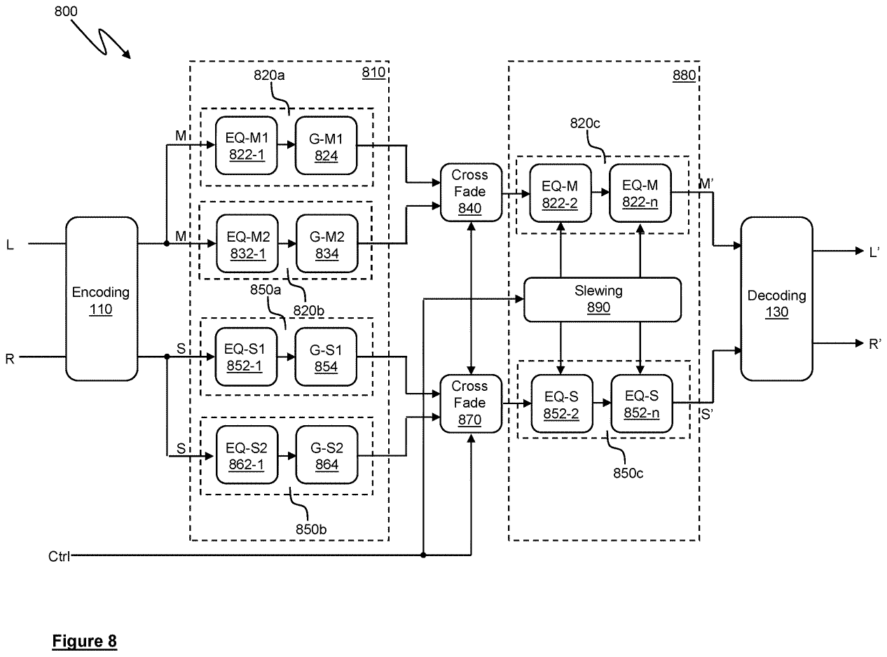

FIG. 8 is a schematic representation of an alternative architecture for the stereo widening and dialog enhancement processing block 120 of the mid-side processing architecture 100 of FIG. 1.

The architecture shown generally at 800 in FIG. 8 separates the processing blocks or modules for processing the mid channel signal M and the side channel signal S output by an encoding block 110 (of the kind described above with reference to FIG. 1) into a first group 810 of processing blocks or modules, which require a change of filter type to switch the architecture 800 between stereo widening and dialog enhance modes, and a second group 880 of processing blocks or modules, which require only gain adjustment to switch the architecture 800 between stereo widening and dialog enhance modes.

The first group 810 of processing blocks or modules includes a first mid channel processing path 820a and a second mid channel processing path 820b.

The first mid channel processing path 820a comprises, in this example, a first equaliser block or module 822-1 and a gain block or module 824. The first equaliser block or module 822-1 of the first mid channel processing path 820a is configured for use in a stereo widening mode of operation of the architecture 800, and thus may implement a high pass filter. Although only a single equaliser block or module 822-1 is shown in the mid channel processing path 820a of FIG. 8, it will be understood by those of ordinary skill in the art that the mid channel processing path 820a may include a plurality of equaliser blocks or modules.

The second mid channel processing path 820b comprises, in this example, a first equaliser block or module 832-1 and a gain block or module 834. The first equaliser block or module 832-1 of the second mid channel processing path 820b is configured for use in a dialog enhance mode of operation of the architecture 800, and may thus implement an all-pass filter, for example. Although only a single equaliser block or module 852-1 is shown in the side channel processing path 850a of FIG. 8, it will be understood by those of ordinary skill in the art that the side channel processing path 850a may include a plurality of equaliser blocks or modules.

Inputs of the first and second mid channel processing paths 820a, 820b are coupled to a first output of the encoding block 110, such that the first and second mid channel processing paths 820a, 820b both receive the mid channel signal M output by the encoding block 110. Outputs of the first and second mid channel processing paths 820a, 820b are coupled to respective first and second inputs of a mid channel cross-fade block or module 840 of the kind described above with reference to FIGS. 3 and 4.

The first group 810 of processing blocks or modules further includes a first side channel processing path 850a and a second side channel processing path 850b.

The first side channel processing path 850a comprises, in this example, a first equaliser block or module 852-1 and a gain block or module 854. The first equaliser block or module 852-1 of the first side channel processing path 850a is configured for operation in the stereo widening mode of operation of the architecture 800, and thus may implement a high shelf filter, for example.

The second side channel processing path 850b comprises, in this example, a first equaliser block or module 862-1 and a gain block or module 864. The first equaliser block or module 862-1 of the second side channel processing path 850b is configured for operation in the dialog enhance mode of operation of the architecture 800, and thus may implement an all-pass filter.

Inputs of the first and second side channel processing paths 850a, 850b are coupled to a second output of the encoding block 110, such that the first and second side channel processing paths 850a, 850b both receive the side channel signal S output by the encoding block 110. Outputs of the first and second side channel processing paths 850a, 850b are coupled to respective first and second inputs of a side channel cross-fade block or module 870 of the kind described above with reference to FIGS. 3 and 4.

The second group 880 of processing blocks or modules includes a third mid channel processing path 820c, a third side channel processing path 850c, and a slewing block or module 890.

The third mid channel processing path 820c in this example comprises a second equaliser block or module 822-2 and an nth equaliser block or module 822-n. The second and nth equaliser blocks or modules 822-2, 822-n of the third mid channel processing path 820c are reconfigurable.

Similarly, the third side channel processing path 850c in this example includes a second equaliser block or module 852-2 and an nth equaliser block or module 852-n. The second and nth equaliser blocks or modules 822-2, 822-n of the third side channel processing path 850c are also reconfigurable.

Outputs of the third mid channel processing path 820c and the third side channel processing path 850c are coupled to respective first and second inputs of a decoding block 130 of the kind described above with reference to FIG. 1.

The slewing block or module 890 is coupled to the reconfigurable equaliser blocks or modules of both the third mid channel processing path 820c and the third side channel processing path 850c, and is operative to control slewing of operational parameters such as filter coefficients of the equaliser blocks or modules 822-2, 822-n of the third mid-channel processing path 822c and the equaliser blocks or modules 852-2, 852-n of the third side channel processing path 852c in response to a control signal indicating that a change in the mode of operation of the architecture 800 is required.

In the example architecture shown in FIG. 8, the slewing block or module 890 is shown as a single block or module coupled to the reconfigurable equaliser blocks or modules of both the third mid channel processing path 820c and the third side channel processing path 850c, but it will be appreciated that separate slewing blocks or modules could be provided for each corresponding pair of equaliser blocks or modules of the third mid-channel processing path 822c and the third side channel processing path 852c. For example, instead of the single slewing block or module 890, separate first to nth slewing blocks or modules could be provided, with the first slewing block or module being coupled to the equaliser block or module 822-2 of the third mid channel processing path 820c and to the equaliser block or module 852-2 of the third side channel processing path 850 to control slewing of the operating parameters (e.g. filter coefficients) of those equaliser blocks or modules, and the nth slewing block or module being coupled to the equaliser block or module 822-n of the third mid channel processing path 820c and to the equaliser block or module 852-n of the third side channel processing path 850 to control slewing of the operating parameters (e.g. filter coefficients) of those equaliser blocks or modules.

The first and second mid channel processing paths 820a, 820b and the first and second side channel processing paths 850a, 850b are always on.

In operation of the architecture 800 in a stereo widening mode of operation, the mid channel cross-fade block or module 840 selects the output of the first mid channel processing path 820a for output to the third mid channel processing path 820c. Similarly, the side channel cross-fade block or module 870 selects the output of the first side channel processing path 850a for output to the third side channel processing path 850c. The third mid channel processing path 820c is configured for operation in the stereo widening mode, with the equaliser blocks or modules 822-2, 822-n being configured with suitable operational parameters such as filter coefficients. The third side channel processing path is similarly configured for operation in the stereo widening mode, with the equaliser blocks or modules 852-2, 852-n being configured with suitable operational parameters such as filter coefficients.

Responsive to a control signal Ctrl indicating that a change to a dialog enhance mode of operation is required, the mid channel cross-fade block or module 840 progressively transitions from outputting the output of the first mid channel processing path 820a to outputting the output of the second mid channel processing path 820b over the predefined transition time, in the manner described above with reference to FIG. 3. Similarly, the side channel cross-fade block or module 870 progressively transitions from outputting the output of the first side channel processing path 850a to outputting the output of the second side channel processing path 850b over the predefined transition time in the manner described above with reference to FIG. 3. Thus, after the end of the predefined transition time, the third mid channel processing path 820c receives the output of the second mid channel processing path 820b, and the third side channel processing path 850c receives the output of the second side channel processing path 850b.

The slewing block or module 890 slews the operating parameters, e.g. filter coefficients, of the equaliser blocks or modules 822-2, 822-n of the third mid channel processing path 820c and the equaliser blocks or modules 852-2, 852-n of the third side channel processing path 850c from a stereo widening configuration to a dialog enhance configuration over a predefined transition time, as described above with reference to FIG. 7. It should be noted that the transition time for this slewing of the operational parameters of the equaliser blocks or modules 822-2, 822-n of the third mid channel processing path 820c and the equaliser blocks or modules 852-2, 852-n of the third side channel processing path 850c may be different from the transition time of the mid channel cross-fade block or module 840 and the side channel cross-fade block or module 870.

Similarly, responsive to a control signal Ctrl indicating that a change from the dialog enhance mode of operation to the stereo widening mode of operation is required, the mid channel cross-fade block or module 840 progressively transitions from outputting the output of the second mid channel processing path 820b to outputting the output of the first mid channel processing path 820a over the predefined transition time, in the manner described above with reference to FIG. 3, and the side channel cross-fade block or module 870 progressively transitions from outputting the output of the second side channel processing path 850b to outputting the output of the first side channel processing path 850c over the predefined transition time, in the manner described above with reference to FIG. 3. The slewing block or module 890 slews the operating parameters, e.g. filter coefficients, of the equaliser blocks or modules 822-2, 822-n of the third mid channel processing path 820c and the equaliser blocks or modules 852-2, 852-n of the third side channel processing path 850c from the dialog enhance configuration to the stereo widening configuration over a predefined transition time, as described above with reference to FIG. 7.

It will be appreciated from the foregoing description that the combination of the selected one of the first and second mid channel processing paths 820a, 820b and the third mid channel processing path 820c forms a first processing path for processing the mid channel signal M to generate a modified mid channel signal M′. Similarly, the combination of the selected one of the first and second side channel processing paths 850a, 850b and the third side channel processing path 850c forms a second processing path for processing the side channel signal S to generate a modified side channel signal S′.

The architecture 800 of FIG. 8 provides improved stability in transitions between operating modes, and reduced distortion during such transitions.

However, the use of always-on parallel first and second mid channel processing paths 820a, 820b the first and second side channel processing paths 850a, 850b may give rise to increased power consumption and use of processing resources, in comparison with the architecture 700 of FIG. 7, for example.

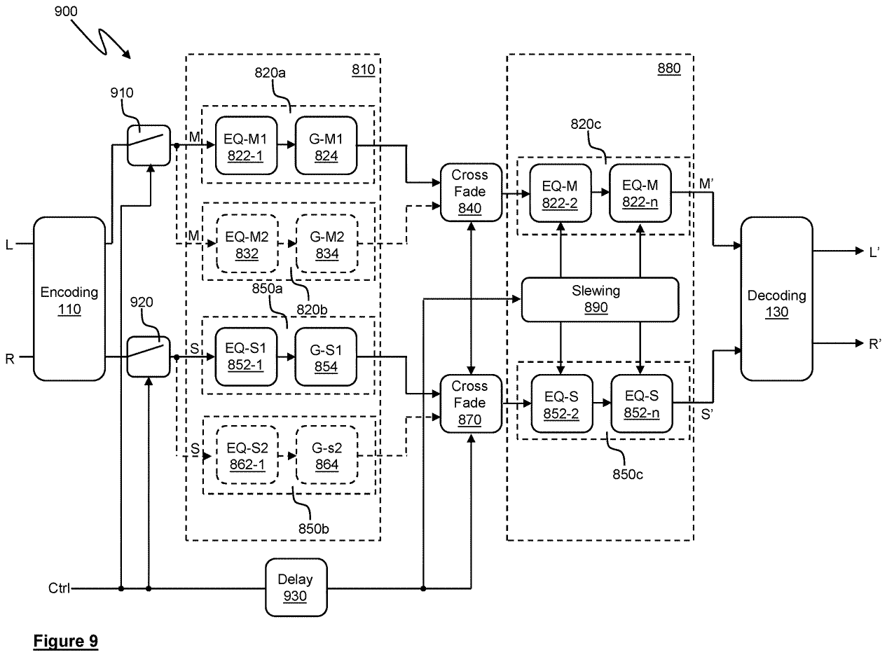

FIG. 9 is a schematic representation of an alternative architecture for the stereo widening and dialog enhancement processing block 120 of the mid-side processing architecture 100 of FIG. 1.

As shown generally at 900 in FIG. 9, this alternative architecture is similar to the architecture 800 described above with reference to FIG. 8, in that it includes a first group 810 of processing blocks or modules comprising first and second mid channel processing paths 820a, 820b and first and second side channel processing paths 850a, 850b, a mid channel cross-fade block or module 830, a side channel cross-fade block or module 870, a second group 880 of processing blocks or modules comprising a third mid channel processing path 820c, a third side channel processing path 850c and a slewing block or module 890. These elements are identical in configuration and operation to the corresponding elements of the architecture 800 of FIG. 8, so will not be described again in detail.

The architecture 900 further includes a first selector switch 910 coupled between a first output of the encoding block 110 and the inputs of the first and second mid channel processing paths 820a, 820b, for selectively coupling the first output of the encoding block 110 to either or both the first or second mid channel processing path 820a, 820b. The architecture 900 similarly includes a second selector switch 920 coupled between a second output of the encoding block 110 and the first and second side channel processing paths 850a, 850b, for selectively coupling the second output of the encoding block 110 to either or both the first or second side channel processing path 850a, 850b.

The architecture 800 further includes a reconfigurable delay block or module 930, configured to receive a control signal Ctrl indicative of a required mode of operation of the architecture 900 and to output a delayed version of the control signal Ctrl to the mid channel cross-fade block or module 840, the side channel cross-fade block or module 870 and the slewing block or module 890.

The architecture 900 differs from the architecture 900 in that the first and second mid channel processing paths 820a, 820b and the first and second side channel processing paths 850a, 850b are not always-on, but are instead selectively activated or enabled in response to the control signal Ctrl.

For example, if stereo widening mode is a default mode of operation of the architecture 800, the first mid channel processing path 820a and the first side channel processing path 850a are usually enabled or activated, and the second mid channel processing path 820b and the second side channel processing path 850b are usually disabled or deactivated. The first selector switch 910 couples the first output of the encoding block 110 to the first mid channel processing path 820a, such that the first mid channel processing path 820a receives the mid channel signal M output by the encoding block 110. The second selector switch 920 couples the second output of the encoding block 110 to the first side channel processing path 850a, such that the second side channel processing path 850b receives the side channel signal S output by the encoding block 110.

Responsive to receiving a control signal Ctrl indicating that the architecture 900 is required to switch to a dialog enhancement mode of operation, the second mid channel processing path 820b and the second side channel processing path 850b are enabled or activated.

The first selector switch 910 couples the first output of the encoding block 110 to the second mid channel processing path 820b, while continuing to couple the first output of the encoding block 110 to the first mid channel processing path 820a, such that both the first and second mid channel processing paths 820a, 820b receive the mid channel signal M output by the encoding block 110.

The second selector switch 920 similarly couples the second output of the encoding block 110 to the second side channel processing path 850b, which continuing to couple the second output of the encoding block 110 to the first side channel processing path 850a, such that both the first and second side channel processing paths 850a, 850b receive the side channel signal S output by the encoding block 110.

Following activation or enabling of the second mid channel processing path 820b, the processing blocks or modules of that path, particularly any equaliser blocks or modules, will require some time to converge from previous states before the second mid channel processing path 820b can begin processing the mid channel signal M correctly. Similarly, following activation or enabling of the second side channel processing path 850b, the processing blocks or modules of that path, particularly any equaliser blocks or modules, will require some time to converge from previous states before the second side channel processing path 850b can begin processing the side channel signal S correctly.

To accommodate the required convergence time of the processing blocks or modules of the second mid channel processing path 820b and the second side channel processing path 850b, the delay block or module 930 applies a delay to the control signal Ctrl, of sufficient duration to allow the processing blocks or modules to converge. After this delay period has elapsed, the control signal Ctrl is supplied to the mid channel cross-fade block or module 840, which cross-fades the signals output by the first and second mid channel processing paths 820a, 820b, and to the side channel cross-fade block or module 870, which cross-fades the signals output by the first and second side channel processing paths 850a, 850b, over the predefined transition time as described above with reference to FIG. 3, to effect a smooth transition from the stereo widening mode of operation to the dialog enhance mode of operation of the architecture 800.

The delayed version of the control signal Ctrl is also supplied to the slewing block or module 890, which slews the operating parameters (e.g. filter coefficients) of the equaliser blocks or modules 822-2-822-n of the third mid channel processing path and the operating parameters (e.g. filter coefficients) of the equaliser blocks or modules 852-2-852-n of the third side channel processing path to transition the equaliser blocks or modules 822-2-822-n, 852-2-852-n from a stereo widening mode configuration to a dialog enhance mode configuration, as described above with reference to FIG. 8.

After the transition from the stereo widening mode to the dialog enhance mode has been completed, the first selector switch 510 decouples the first mid channel processing path 820a from the first output of the encoding block 110, while continuing to couple the first output of the encoding block 110 to the second mid channel processing path 820b, such that only the second mid channel processing path 820b receives the mid channel signal M output by the encoding block 110. Internal states of the processing blocks or modules of the first mid channel processing path 820a are frozen, and the first mid channel processing path 820a is deactivated or disabled.

The second selector switch 920 similarly decouples the first side channel processing path 850a from the second output of the encoding block 110, while continuing to couple the second output of the encoding block 110 to the second side channel processing path 850b, such that only the second side channel processing path 850b receives the side channel signal S output by the encoding block 110. Internal states of the processing blocks or modules of the first side channel processing path 850a are frozen, and the first side channel processing path 850a is deactivated or disabled.

Responsive to a control signal Ctrl indicating that a switch from the dialog enhance mode to the stereo widening mode of the architecture 900 is required, the first mid channel processing path 820a and the first side channel processing path 850a are enabled or activated.

The first selector switch 910 couples the first output of the encoding block 110 to the first mid channel processing path 820a, while continuing to couple the first output of the encoding block 110 to the second mid channel processing path 820b, such that both the first and second mid channel processing paths 820a, 820b receive the mid channel signal M output by the encoding block 110.

The second selector switch 920 similarly couples the second output of the encoding block 110 to the first side channel processing path 850a, which continuing to couple the second output of the encoding block 110 to the second side channel processing path 850b, such that both the first and second side channel processing paths 850a, 850b receive the side channel signal S output by the encoding block 110.

Following activation or enabling of the first mid channel processing path 820a, the processing blocks or modules of that path, particularly any equaliser blocks or modules, will require some time to converge from previous states before the first mid channel processing path 820a can begin processing the mid channel signal M correctly. Similarly, following activation or enabling of the first side channel processing path 850a, the processing blocks or modules of that path, particularly any equaliser blocks or modules, will require some time to converge from previous states before the first side channel processing path 850a can begin processing the side channel signal S correctly.

Again, to accommodate the required convergence time of the processing blocks or modules of the first mid channel processing path 820a and the first side channel processing path 850a, the delay block or module 930 applies a delay to the control signal Ctrl, of sufficient duration to allow the processing blocks or modules to converge. After this delay period has elapsed, the control signal Ctrl is supplied to the mid channel cross-fade block or module 840, which cross-fades the signals output by the first and second mid channel processing paths 820a, 820b, and to the side channel cross-fade block or module 840, which cross-fades the signals output by the first and second side channel processing paths 850a, 850b, over the predefined transition time as described above with reference to FIG. 3, to effect a smooth transition from the dialog enhance mode of operation to the stereo widening mode of operation of the architecture 900.

The delayed version of the control signal Ctrl is also supplied to the slewing block or module 890, which slews the operating parameters (e.g. filter coefficients) of the equaliser blocks or modules 822-2-822-n of the third mid channel processing path and the operating parameters (e.g. filter coefficients) of the equaliser blocks or modules 852-2-852-n of the third side channel processing path to transition the equaliser blocks or modules 822-2-822-n, 852-2-852-n from a the dialog enhance mode configuration to the stereo widening mode configuration, as described above with reference to FIG. 8.

After the transition from the dialog enhance mode to the stereo widening mode has been completed (e.g. after the transition time of the cross-fade blocks or modules 330, 360 has elapsed), the first selector switch 910 decouples the second mid channel processing path 820b from the first output of the encoding block 110, while continuing to couple the first output of the encoding block 110 to the first mid channel processing path 820a, such that only the first mid channel processing path 820a receives the mid channel signal M output by the encoding block 110. Internal states of the processing blocks or modules of the second mid channel processing path 820b are frozen, and the second mid channel processing path 820b is deactivated or disabled.

The second selector switch 920 similarly decouples the second side channel processing path 850b from the second output of the encoding block 110, while continuing to couple the second output of the encoding block 110 to the first side channel processing path 850a, such that only the first side channel processing path 850a receives the side channel signal S output by the encoding block 110. Internal states of the processing blocks or modules of the second side channel processing path 850b are frozen, and the second side channel processing path 850b is deactivated or disabled.

Thus, in normal operation of the architecture 900 in either the stereo widening mode or the dialog enhance mode, only one of the first and second mid channel processing paths 820a, 820b is enabled or activated, and only one of the first and second side channel processing paths 850a, 850b is enabled or activated. This may reduce the power consumption and use of processing resource of the architecture 900, in comparison with the architecture 800 of FIG. 8.

The systems described above may be implemented in a digital signal processor (DSP) integrated circuit, e.g. as hardware blocks or as software blocks or modules executing on one or more suitably DSP hardware processing blocks or modules. In particular, the processing blocks or modules described above may be implemented in a digital signal processor (DSP) integrated circuit, e.g. as hardware blocks or as software blocks or modules executing on one or more suitably DSP hardware processing blocks or modules.

The systems described above with reference to the accompanying drawings may be incorporated in a host device such as a laptop, notebook, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A reconfigurable audio system operable in a first mode of operation and a second mode of operation, the reconfigurable audio system comprising:
a first processing path for processing a first signal to generate a first processed output signal, wherein the first processing path comprises a first set of processing blocks; and
a second processing path for processing a second signal to generate a second processed output signal, wherein the second processing path comprises a second set of processing blocks,
wherein, responsive to a command to switch between the first mode of operation and the second mode of operation, the system is operative to adjust operating parameters of at least a subset of the first or second set of processing blocks over a slewing transition period.

2. The reconfigurable audio system of claim 1, further comprising a slewing block for controlling adjustment of the operating parameters of the subset of the first or second set of processing blocks.

3. The reconfigurable audio system of claim 1, further comprising an encoder block for generating the first and second signals.

4. The reconfigurable audio system of claim 3, wherein the first signal is a mid channel signal and the second signal is a side channel signal, and wherein the encoder block is configured to generate the mid channel signal and the side channel signal from left channel and right channel stereo audio signals.

5. The reconfigurable audio system of claim 3, further comprising a decoder block for generating output left channel and right channel audio signals from the first and second processed output signals.

6. The reconfigurable audio system of claim 1, wherein the processing blocks of the first and second sets of processing blocks comprise digital filters.

7. The reconfigurable audio system of claim 6, wherein the digital filters comprise infinite impulse response (IIR) filters.

8. The reconfigurable audio system of claim 6, wherein the operating parameters comprise filter coefficients.

9. The reconfigurable audio system of claim 1, wherein:
the first processing path comprises a first subset of processing blocks of a first type and a second subset of processing blocks of a second type; and
the second processing path comprises a first subset of processing blocks of a first type and a second subset of processing blocks of a second type.

10. The reconfigurable audio system of claim 9, wherein, responsive to the command to switch between the first mode of operation and the second mode of operation, the reconfigurable audio system is operative to adjust operating parameters of the second subset of processing blocks of the first or second processing path over the slewing transition period.

11. The reconfigurable audio system of claim 9, further comprising:
a first parallel processing path in parallel with the first subset of processing blocks of the first processing path; and
a second parallel processing path in parallel with the first subset of processing blocks of the second processing path.

12. The reconfigurable audio system of claim 11, wherein:
the first parallel processing path comprises a first set of parallel processing blocks, for use in the second mode of operation, wherein the first set of parallel processing blocks are of a different configuration than the processing blocks of the first subset of processing blocks of the first processing path; and
the second parallel processing path comprises a second set of parallel processing blocks, for use in the second mode of operation, wherein the second set of parallel processing blocks are of a different configuration than the processing blocks of the first subset of processing blocks of the second processing path.

13. The reconfigurable audio system of claim 11 further comprising:
a first cross-fade block operable, responsive to the command to switch between the first mode of operation and the second mode of operation, to transition its output between an output signal of the first subset of processing blocks of the first processing path and an output signal of the first parallel processing path over a cross-fade transition period; and
a second cross-fade block operable, responsive to the command to switch between the first mode of operation and the second mode of operation, to transition its output between an output signal of the first subset of processing blocks of the second processing path and an output signal of the second parallel processing path over the cross-fade transition period

14. The reconfigurable audio system of claim 11, further comprising:
a first selector switch configured to selectively supply an input signal to the first subset of processing blocks of the first processing path or to the first parallel processing path; and
a second selector switch configured to selectively supply an input signal to the first subset of processing blocks of the second processing path or to the second parallel processing path.

15. The reconfigurable audio system of claim 1, wherein the first processing path and the second processing path comprise an equal number of processing blocks.

16. A digital signal processor (DSP) integrated circuit implementing the reconfigurable audio system of claim 1.

17. A host device comprising the reconfigurable audio system of claim 1.

18. The host device of claim 17, wherein the host device comprises a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.

19. A reconfigurable audio system operable in a plurality of modes of operation, the reconfigurable audio system comprising:
a first processing path for processing a first signal to generate a first processed output signal, wherein the first processing path comprises a reconfigurable processing module;
a second processing path for processing a second signal to generate a second processed output signal, wherein the second processing path comprises a reconfigurable processing module; and
a slewing block,
wherein, responsive to a command to change between modes of operation, the slewing block is operative to slew operational parameters of the reconfigurable processing modules of the first and second processing paths to effect a change between modes of operation of the reconfigurable audio system.

20. A reconfigurable audio system operable in a first mode of operation and a second mode of operation, the reconfigurable audio system comprising:
a first processing path for processing a first signal, wherein the first processing path comprises a first set of processing blocks;
a first parallel processing path for processing the first signal, wherein the first parallel processing path comprises a first set of parallel processing blocks;
a second processing path for processing a second signal, wherein the second processing path comprises a second set of processing blocks;
a second parallel processing path for processing the second signal, wherein the second processing path comprises a second set of parallel processing blocks;
a first cross-fade block having a first input coupled to an output of the first processing path, a second input coupled to an output of the first parallel processing path and an output; and
a second cross-fade block having a first input coupled to an output of the second processing path, a second input coupled to an output of the second parallel processing path and an output;
wherein, responsive to a command to switch between the first mode of operation and the second mode of operation:
the first cross-fade block is operative to transition its output between its first input and its second input over a cross-fade transition period; and
the second cross-fade block is operative to transition its output between its first input and its second input over the cross-fade transition period.

21. A reconfigurable audio system operable in a first mode of operation and a second mode of operation, the reconfigurable audio system comprising:
a first processing path comprising;
first and second parallel sets of processing blocks, wherein the first and second parallel sets of processing blocks are of a first type;
a first cross-fade block coupled to outputs of the first and second parallel sets of processing blocks of the first processing path; and
a third set of processing blocks coupled to an output of the first cross-fade block, wherein the third set of processing blocks of the first processing path are of a second type;
a second processing path comprising:
first and second parallel sets of processing blocks, wherein the first and second parallel sets of processing blocks are of the first type;
a second cross-fade block coupled to outputs of the first and second parallel sets of processing blocks of the second processing path; and
a third set of processing blocks coupled to an output of the second cross-fade block, wherein the third set of processing blocks of the second processing path are of the second type; and
a slewing block coupled to the third set of processing blocks of the first processing path and to the third set of processing blocks of the second processing path,
wherein, responsive to a command to switch between the first mode of operation and the second mode of operation:
the first cross-fade block is operative to transition its output between the output of the first set of parallel processing blocks and the output of the second set of parallel processing blocks of the first processing path over a cross-fade transition period;
the second cross-fade block is operative to transition its output between the output of the first set of parallel processing blocks and the output of the second set of parallel processing blocks of the second processing path over the cross-fade transition period; and
the slewing block is operative to slew operating parameters of the third set of processing blocks of the first processing path and to slew operating parameters of the third set of processing blocks of the second processing path over a slewing transition period.
